(19) United States
(12) Patent Application Publication
(10) Pub. No.: US 2025/0145149 A1
(43) Pub. Date: May 8, 2025

(54) CONTROL SYSTEM FOR A VEHICLE

(71) Applicant: ZF CV Systems Global GmbH, Bern (CH)

(72) Inventors: Oliver Wulf, Neustadt (DE); Klaus Plähn, Seelze (DE); Benjamin Bieber, Wedemark (DE); Jonas Böttcher, Hannover (DE)

(21) Appl. No.: 19/019,086

(22) Filed: Jan. 13, 2025

Related U.S. Application Data
(63) Continuation of application No. PCT/EP2023/064956, filed on Jun. 5, 2023.

(30) Foreign Application Priority Data
Jul. 18, 2022 (DE) 10 2022 117 875.7

(51) Int. Cl. B60W 30/04; B60W 50/14

(52) U.S. Cl. CPC B60W 30/04; B60W 50/14; B60W 2300/14; B60W 2530/10; B60W 2530/201

(57) ABSTRACT

A vehicle control system is for a vehicle. The control system has a first control unit configured to determine a manipulated variable of a vehicle actuator of the vehicle and to output same at an actuator interface, a second control unit, which can be connected to a vehicle network and a private network of the vehicle to receive signals that include two or more geometric characteristics and two or more load characteristics of a current vehicle configuration of the vehicle, and a control system network. The second control unit is configured to define a driving dynamics limit value of the current vehicle configuration using the characteristics and to provide the driving dynamics limit value on the control system network. The first control unit is configured to determine the manipulated variable using the driving dynamics limit value.

### CROSS-REFERENCE TO RELATED APPLICATIONS

This application is a continuation application of international patent application PCT/EP2023/064956, filed Jun. 5, 2023, designating the United States and claiming priority from German application 10 2022 117 875.7, filed Jul. 18, 2022, and the entire content of both applications is incorporated herein by reference.

### TECHNICAL FIELD

The disclosure relates to a vehicle control system for a vehicle, wherein the vehicle has a vehicle network and at least one private network, the vehicle control system having a first control unit, which is configured to determine at least one manipulated variable of a vehicle actuator of the vehicle and to output same at an actuator interface. The disclosure furthermore relates to a vehicle and to a vehicle control method.

### BACKGROUND

An experienced professional driver can estimate the driving stability that can be expected from a vehicle even before the start of a trip, ensuring that the vehicle is moved safely in road traffic. The driving style adopted by an experienced driver matches the prevailing boundary conditions and enables the vehicle to be steered safely. To the extent required, an experienced driver will adapt their chosen driving style in such a way that vehicle instability is avoided and the vehicle is guided with the required accuracy in a lane.

In contrast, an inexperienced driver cannot correctly assess the vehicle behavior that is to be expected, or can do so only to a limited extent. Drivers referred to as “virtual drivers”, which control autonomous vehicles or perform partial tasks in the control of autonomous vehicles, have not hitherto been able to ensure correct assessment of stability behavior. If assessment of the current driving stability and of the necessary space requirement is inadequate, this leads to instability, which is recognized too late, or not at all, by an inexperienced driver or a virtual driver. Conventional stability control systems in a vehicle intervene to correct the driving behavior of the vehicle only when certain limits are exceeded. Such interventions therefore take place too late and are associated with an increased space requirement, with the result that a number of corrections may be required or, in the worst case, an accident may be unavoidable. There is therefore a need for vehicle control systems which reliably prevent vehicle instability.

US 2013/0085639 A1 discloses a method for stability control of a vehicle, including the steps of: monitoring vehicle information with an electronic control unit; detecting an approaching unstable driving condition from the vehicle information with an electronic control unit prior to the occurrence of the unstable driving condition; and sending at least one output signal of a first signal series from the electronic control unit to at least one vehicle system to apply at least one proactive vehicle stability measure prior to the occurrence of the unstable driving condition. To detect the approaching unstable driving condition, the electronic control unit receives information on weather conditions and road conditions as well as road map data. The disadvantage with the above-described method according to US 2013/0085639A1 is that vehicle-specific characteristics are not taken into account and approaching instability of the commercial vehicle is detected only inadequately or not at all. Moreover, the method for stability control is carried out by a single electronic control unit which, in the event of a fault, represents a considerable safety risk.

### SUMMARY

It is an object of the disclosure to improve safety and precision in the control of vehicles.

In a first aspect, the object is, for example, achieved by a vehicle control system for a vehicle, wherein the vehicle has a vehicle network and at least one private network, the vehicle control system having a first control unit, which is configured to determine at least one manipulated variable of a vehicle actuator of the vehicle and to output same at an actuator interface, a second control unit, which can be connected to the vehicle network and the private network in order to receive signals that include two or more geometric characteristics and two or more load characteristics of a current vehicle configuration of the vehicle, and a control system network, which connects the first control unit and the second control unit, wherein the second control unit is configured to define a driving dynamics limit value of the current vehicle configuration using the two or more geometric characteristics and the two or more load characteristics and to provide the driving dynamics limit value on the control system network, wherein the first control unit is configured to determine the manipulated variable using the driving dynamics limit value.

During vehicle operation, the first control unit determines a manipulated variable of the vehicle actuator and outputs this manipulated variable at the actuator interface in order to control the vehicle. The determination of the manipulated variable is carried out in order to control the vehicle in a driving situation or to perform a driving task. The first control unit is preferably configured to implement a (partially) autonomous driving function. The autonomous driving function can be a trajectory planning process and/or a position control process of a fully autonomous vehicle. However, the first control unit can likewise preferably also be configured to implement a driver assistance function. The driver assistance function is or preferably includes an adaptive cruise control, an emergency braking assistant, a lane keeping assistant and/or a driving stability control system. For example, the first control unit can determine a steering manipulated variable for a steering system of the vehicle in order to steer the vehicle around a bend.

The first control unit can preferably also determine a plurality of manipulated variables for one or more vehicle actuators and provide them at the actuator interface. The vehicle actuators influence the state of movement of the vehicle. The vehicle actuator preferably is or includes a steering system, a brake, a brake system and/or an engine of the vehicle. The vehicle actuators are controlled via the manipulated variables and perform a driving dynamics intervention corresponding to the manipulated variable on the vehicle. For example, a required brake pressure at a brake modulator of a brake system can be specified as a manipulated variable in order to output a corresponding braking force at a service brake connected to the brake modulator. The first control unit determines the manipulated variables of the vehicle actuators, which are used, in turn, to influence the state of movement of the vehicle.

It should be understood that the first control unit can also carry out just a partial task in the control of the vehicle actuators. Thus, the manipulated variable determined by the first control unit and output at the actuator interface may also be just an intermediate variable of a vehicle actuator. For example, the first control unit can output a setpoint deceleration at the actuator interface as a manipulated variable, which is then converted in a brake modulator into a brake pressure corresponding to the setpoint deceleration. This brake pressure is then output by the brake modulator to a brake cylinder of a service brake in order to achieve the setpoint deceleration.

The second control unit can be connected to the vehicle network and the private network of the vehicle in order to receive signals including two or more geometric characteristics and two or more load characteristics of the vehicle. The vehicle network and the private network are networks of the vehicle. The vehicle network is preferably a vehicle bus system, particularly preferably a vehicle CAN. The private network is preferably a private network of a vehicle subsystem. As a particular preference, the private network is a steering system network of a steering system of the vehicle.

The geometric characteristics and load characteristics at least partially represent a current vehicle configuration of the vehicle, which relates both to vehicle-specific aspects and to load-specific aspects. The geometric characteristics represent the geometry of the vehicle. In addition to or instead of geometric dimensions, the geometric characteristics can preferably also contain quantitative data (for example, a number of axles of the vehicle). Geometric characteristics are or include, in particular, geometric variables that define the driving dynamics of the vehicle, such as a wheelbase of the vehicle, axle spacings between axles of the vehicle, a track width of the vehicle, a distance between a rear axle of the vehicle and a coupling point of a trailer, or a configuration type of a trailer vehicle (for example, drawbar trailer or center-axle trailer).

The load characteristics represent loads acting on the vehicle, which may result from the dead weight of the vehicle and from a load on the vehicle. Thus, a current vehicle configuration of an unladen vehicle is different from a current vehicle configuration of the same vehicle in the laden state. A load characteristic can preferably be or include a wheel load, an axle load, a total vehicle mass, a mass of part of the vehicle and/or a location of a center of mass of the vehicle or of part of the vehicle. The second control unit takes into account the geometric characteristics and load characteristics determined when defining a vehicle dynamics limit value. The driving dynamics limit value is at least partially matched to the current vehicle configuration and in this way enables particularly safe control of the vehicle. Thus, a risk of instability resulting from unfavorable loading of the vehicle can be detected and taken into account in the driving dynamics limit value. The first control unit determines the manipulated variable for the vehicle actuator using the driving dynamics limit value. This ensures that the driving dynamics limit value is complied with in the control of the vehicle.

The control system network connects the first control unit and the second control unit and serves at least for exchange of the driving dynamics limit value. The control system network allows separate and particularly secure exchange of the driving dynamics limit value. The control system network is preferably a bus system, particularly preferably a CAN bus. The architecture according to the disclosure with a first control unit, a second control unit and a control system network ensures a high level of fail safety and is economical. The division of work between the control units allows the use of a lower computing power per control unit and high-speed control. Moreover, the determination of the manipulated variable of the vehicle actuator that can be carried out by the first control unit is safety-critical, in particular, and therefore the provision of a second control unit prevents interference with the first control unit. Furthermore, it is preferably the case that only the second control unit is connectable to the vehicle network and to the at least one private network on the input side (that is, to receive signals). The second control unit forms an input side and protects the first control unit from faulty signals. Moreover, the second control unit carries out preprocessing of the signals, thus reducing the complexity of tasks for the first control unit.

As a particular preference, the vehicle is a commercial vehicle. A commercial vehicle (CV), also referred to as a commercial motor vehicle (CMV), is a motor vehicle which, according to its construction and equipment, is intended for the transportation of people or goods or for towing trailers but is not a passenger car or motorcycle, being rather a bus, a heavy goods vehicle, a tractor or a crane truck, for example. In the context of the present disclosure, the commercial vehicle can be a simple commercial vehicle, often also referred to in English as a “rigid vehicle”, or else a vehicle train including a towing vehicle and one or more trailer vehicles.

It is an insight underlying the disclosure that, in the case of modern vehicles, especially commercial vehicles, a large number of geometric characteristics and load characteristics are already known. Thus, various geometric characteristics and load characteristics are processed in conventional vehicle systems, for example, an electronic brake system. These characteristics are therefore already included by signals which are provided on a vehicle network or a private network of the vehicle. The disclosure makes use of this insight since the second control unit can be connected to the vehicle network and the private network and can thus access the characteristics. The vehicle control system can therefore be integrated particularly easily into a vehicle. Furthermore, the vehicle control system can be used economically, especially since it is possible to dispense largely or completely with separate sensor systems.

The second control unit is preferably a different control unit from the first control unit. Provision may also be made for the second control unit and the first control unit to be functionally distinguishable subunits of one control unit.

In a first embodiment, the second control unit is configured to predict dynamic properties of the current vehicle configuration using the two or more geometric characteristics and the two or more load characteristics and to define the at least one driving dynamics limit value on the basis of the predicted dynamic properties. Thus, a behavior of the vehicle is predictable. Dynamic properties are preferably yaw behavior of the towing vehicle, articulation behavior of the trailer vehicle or of the trailer vehicles, natural angular frequencies of the vehicle and/or damping levels of the vehicle or of the dynamic system formed by the vehicle. Prediction of the dynamic properties of the current vehicle configuration is preferably model-based. For this purpose, the second control unit can preferably be configured to individualize a basic vehicle model using the geometric characteristics and the load characteristics, and to determine the dynamic behavior of the vehicle using the individualized vehicle model.

The driving dynamics limit value is preferably a maximum permissible vehicle speed, a maximum permissible lateral acceleration, a maximum permissible vehicle acceleration, a maximum permissible vehicle deceleration, a maximum permissible steering angle gradient or a minimum permissible bend radius of the vehicle. The vehicle control system according to the disclosure can also be configured to define a plurality of driving dynamics limit values for the vehicle, a maximum permissible vehicle speed being defined as a first driving dynamics limit value and a maximum permissible lateral acceleration being defined as a second driving dynamics limit value, for example. The maximum permissible vehicle speed is not necessarily a speed at which instability of the vehicle immediately occurs when it is exceeded by the vehicle. On the contrary, instability may occur only when there is corresponding excitation, for example, when an avoidance maneuver is necessary. The maximum permissible vehicle speed can preferably be selected so that, at this vehicle speed, stable travel of the vehicle is still assured, even in the case of sudden avoidance maneuvers and/or cornering.

The second control unit is preferably configured to monitor the signals for a change in a characteristic on which the definition of the at least one driving dynamics limit value is based and to adapt the driving dynamics limit value to the change. Adaptation of the driving dynamics limit value may also be a redefinition of the driving dynamics limit value or of some other driving dynamics limit value. Adaptation of the at least one driving dynamics limit value ensures that the driving dynamics limit value is always adapted to the current vehicle configuration. Thus, a dynamic behavior of the vehicle changes significantly under certain circumstances if the vehicle is laden or unladen. However, loading also results in a change in at least one load characteristic that underlies the definition of the driving dynamics limit value, and therefore the driving dynamics limit value is adapted or redefined to the changed circumstances. In this way, the gain in safety that can be achieved via the vehicle control system is further increased. Detection of the change in a characteristic underlying the definition of the at least one driving dynamics limit value is preferably performed while the vehicle is in operation. Adaptation is preferably accomplished by a new prediction of the stability behavior and redefinition of the driving dynamics limit value. Monitoring of the signals for a change in a characteristic underlying the definition of the at least one driving dynamics limit value can also be performed when the vehicle is stationary. The second control unit is preferably configured to store the driving dynamics limit value in a nonvolatile memory. Thus, the driving dynamics limit value can preferably be provided as a starting value by the second control unit when the vehicle is started again.

In an embodiment of the vehicle control system, the first control unit is a virtual driver for the autonomous control of a vehicle, which is configured to plan a trajectory in order to perform a driving task of the vehicle. The virtual driver is a unit which performs at least partial tasks of an autonomous control process for the vehicle. The at least one partial task of the autonomous control process for the vehicle includes trajectory planning. The virtual driver carries out trajectory planning and obtains a trajectory which is provided for the completion of a driving task, for example, an autonomous trip from point to A to point B. The trajectory includes at least one planned path (setpoint path) that is to be travelled by the vehicle to complete the driving task. The trajectory furthermore includes at least one driving dynamics specification. This driving dynamics specification preferably is or includes a speed specified for traveling the path or a speed profile specified for traveling the path.

The first control unit is preferably configured to provide the trajectory on the control system network, wherein the second control unit is configured to determine whether the trajectory infringes the driving dynamics limit value. The trajectory includes at least one driving dynamics specification, for example, a vehicle speed for a driving task. The second control unit is preferably configured to check the trajectory and to determine whether the dynamic specification included by the trajectory infringes the driving dynamics limit value. Depending on the type of driving dynamics limit value, infringement can involve exceeding or undershooting the driving dynamics limit value. If the driving dynamics limit value is a maximum permissible vehicle speed, for example, this driving dynamics limit value is infringed if a setpoint vehicle speed included by the trajectory exceeds the maximum permissible vehicle speed. If, on the other hand, the driving dynamics limit value is a minimum permissible bend radius for the vehicle, this driving dynamics limit value is infringed if the trajectory includes a path with a smaller bend radius. In the embodiment, a redundancy is created which further increases the gain in safety achieved via the vehicle control system. In general, the first control unit uses the driving dynamics limit value in planning the trajectory. If, however, in the event of a fault, the first control unit does not use the driving dynamics limit value in planning the trajectory, or does not use it correctly, then an imminent instability of the vehicle can be detected by the second control unit since it determines an infringement of the driving dynamics limit value by the trajectory. Updating of the driving dynamics limit values may furthermore be required on the basis of environmental information. This is the case, for example, if there is a risk or increased risk that the vehicle will tip over on account of a roadway inclination transverse to the direction of travel while the vehicle is cornering. Environmental information allowing for the roadway inclination may not yet be available during trajectory planning, and therefore compliance with the pre-planned trajectory may lead to unstable vehicle states. The second control unit can be configured to determine, on the basis of environmental information, preferably provided on the vehicle network and/or a private network, whether the trajectory infringes a driving dynamics limit value.

The geometric characteristics preferably include at least a number of the axles of the vehicle and an axle spacing between axles of the vehicle. As a particular preference, the geometric characteristics include all the axle spacings between the axles of the vehicle. Wheels on the axles of the vehicle form the point of contact of the vehicle with the roadway. The axle spacing, which represents a distance between these points of contact, therefore has a considerable effect on the dynamic behavior of the vehicle and consequently forms a geometric characteristic which is particularly suitable for representation of the current vehicle configuration. If the geometric characteristics determined include at least a number of the axles of the vehicle and an axle spacing, the dynamic behavior of the vehicle can be predicted with high accuracy and comparatively low computing effort. Other or alternatively preferred geometric characteristics are, for example, a location of a coupling point of a towing vehicle, a location of a central point of an axle group formed by a plurality of axles, a track width of the vehicle and/or a wheelbase of the vehicle or of a sub-vehicle of the vehicle. However, the method can also be carried out when only some or none of the axle spacings are known. When the vehicle length is known, for example, an axle spacing of the vehicle can preferably also be approximated.

In an embodiment, the second control unit is configured to receive signals that represent a real driving state of the vehicle and to determine whether the at least one driving dynamics limit value is being infringed in the real driving state. The real driving state can also be referred to as an actual driving state. The signals which represent the real driving state of the vehicle are preferably provided on the vehicle network and/or private network. The second control unit is preferably configured to receive from the vehicle network and/or private network signals which represent the real driving state of the vehicle.

In an embodiment, the second control unit is furthermore configured to provide a warning signal if the driving dynamics limit value is infringed. The warning signal can alert a driver of the vehicle to imminent instability. The warning signal can be configured as a simple indication. However, the warning signal may preferably also include information on the driving dynamics limit value infringed. The vehicle control system is preferably configured to output a brake actuating signal as a warning signal at the actuator interface if the vehicle dynamics limit value is infringed. As a particular preference, the brake actuating signal is a time-limited brake actuating signal which is provided for a time period of 5 s or less, preferably 2 s or less, particularly preferably 1 s or less. The warning signal configured as a brake actuating signal allows brief initial braking of the vehicle, thereby reliably warning a driver of the vehicle. In this way, a haptic warning to a driver of the vehicle can be achieved. The brief initial braking to produce a haptic warning is preferably performed using deceleration values from a driver assistance system of the vehicle, in particular an emergency braking system of the vehicle.

The vehicle control system preferably has a man-machine interface for outputting the warning signal provided. The man-machine interface preferably is or includes a warning lamp, a loudspeaker, a heads-up display, a vibration motor and/or a screen. A man-machine interface for outputting the warning signal allows easy perception of the warning signal by a human driver, thus enabling the driver to allow for the driving dynamics limit value or the infringement thereof in the control of the vehicle. For example, a maximum permissible vehicle speed can be indicated as a warning signal on a speedometer of the vehicle.

The second control unit can preferably be configured to provide the warning signal on the control system network. Thus, the warning signal can also be determined by the first control unit or be provided at the latter. The first control unit is preferably configured to replan the trajectory for performing the driving task of the vehicle when the warning signal is provided on the control system network.

The private network can preferably be a brake system network of the vehicle. The brake system network is preferably a brake bus system. As a particular preference, the private network is a brake CAN. Signals that represent a state of movement of one or more wheels of the vehicle are provided on the brake bus system during the operation of the vehicle. For example, rotational speed signals that represent a rotational speed of a wheel of the vehicle can be provided on the brake bus system. These signals can advantageously be used by the second control unit to define the driving dynamics limit value and/or to determine whether the at least one driving dynamics limit value is being infringed in the real driving state. In addition or as an alternative to rotational speed signals, sensor signals from a stability control system of the vehicle can be provided on the brake system network (and/or preferably the vehicle network). These sensor signals preferably represent a yaw rate, a steering wheel angle and/or a lateral acceleration of the vehicle.

Furthermore, signals provided on the brake bus system preferably often include geometric characteristics (wheelbases, number/position of the axles, steering ratio) of the vehicle, which are used by the brake system, for example, in a stability control system, in particular an anti-lock brake system (ABS). In the context of the present disclosure, a stability control system is a system which is configured to at least partially control driving stability of the vehicle. In addition or as an alternative to an ABS, a stability control system can preferably also be or include a traction control system (ASR) or an electronic stability control (ESC). The second control unit can be connected to the brake bus system, thus enabling the vehicle control system to determine the signals provided thereon. The determination of the geometric characteristics and/or the determination of the load characteristics is thereby made easier.

In an embodiment, the second control unit is configured to detect interventions of a stability control system during operation of the vehicle, and to define the driving dynamics limit value using dynamic restrictions on the vehicle that can be derived from the interventions of the stability control system. A stability control system of this kind is preferably an anti-lock brake system (ABS), a traction control system (ASR) and/or an electronic stability control (ESC). The stability control system can preferably also be an electronic braking force distributor or include an electronic braking force distributor. The second control unit is preferably configured to detect interventions by a plurality of stability control systems and to take these into account in defining the driving dynamics limit value. In this way, the second control unit can take into account both the intervention of an anti-lock brake system and that of an ESC. A selected drive torque that is too high at wheels of the vehicle leads to considerable tire slip (spinning of the wheels), especially when the roadway is wet or slippery. A traction control system prevents or minimizes this tire slip by selective braking of the spinning wheel and a matching intervention into an engine torque of a drive of the vehicle. Drive slip as described above occurs especially in the case of unladen or light vehicles on account of relatively low wheel loads. If an intervention by the traction control system has already occurred (a historical control intervention), this can also advantageously be taken into account in defining the driving dynamics limit value. From the intervention of the traction control system, it is possible to determine what maximum drive torque will just fail to lead to tire slip that infringes a predefined tire slip limit value. Since there is always tire slip when forces are being transmitted (the vehicle is moving), a traction control system intervenes only when a predefined tire slip limit value is exceeded and the wheel (almost) spins. This maximum drive torque can then be derived as a dynamic restriction from the intervention and used in the definition of the driving dynamics limit value by the second control unit. Thus, for example, a maximum acceleration of the vehicle, which depends on the maximum achievable drive torque, can be defined as a driving dynamics limit value.

The second control unit is preferably configured to determine a center of mass height of the vehicle, taking into account signals which represent the rolling behavior of the vehicle, and to define the driving dynamics limit value using the center of mass height determined. Rolling refers to a rotary motion of the vehicle about its vehicle longitudinal axis. Signals that represent the rolling behavior of the vehicle are preferably signals which are provided by an electronically controllable air spring system of the vehicle. The signals preferably represent axle loads on axles and/or wheel loads on wheels of the vehicle. If the lateral acceleration is known, it is possible to infer a center of mass height of the vehicle from changes in the loads acting on the wheels of the vehicle. Thus, the loading of a wheel on the outside of a bend increases more sharply on a vehicle with a high center of mass than on a vehicle with a low center of mass at the same lateral acceleration. The signals that represent the rolling behavior of the vehicle are preferably signals that represent an actual lateral acceleration of the vehicle and an actual yaw rate of the vehicle. The second control unit is preferably configured to determine a setpoint lateral acceleration from the actual yaw rate of the vehicle and to determine a roll angle of the vehicle from the setpoint lateral acceleration and the actual lateral acceleration. In this way, the component (the setpoint lateral acceleration) resulting from stable cornering can be calculated from the measured actual lateral acceleration. The remaining component of the actual lateral acceleration results from gravitational effect due to the tilting of a measuring device (preferably of an ESC), thus enabling the roll angle to be determined. The second control unit is preferably configured to take into account a roadway inclination in determining the center of mass height. The center of mass height affects a tipping inclination of the vehicle. The center of mass height can preferably be used to define a maximum permissible lateral acceleration of the vehicle as the driving dynamics limit value.

In an embodiment, the vehicle is a vehicle train including a towing vehicle and at least one trailer vehicle, wherein the second control unit can be connected to a trailer network of the vehicle in order to receive trailer signals, which include a geometric characteristic and/or a load characteristic of the current vehicle configuration of the vehicle. In the embodiment, the at least two or more geometric characteristics and two or more load characteristics can be provided at the second control unit via the vehicle network, the private network and additionally also via a trailer network if the vehicle is a vehicle train. The trailer network connects the towing vehicle to the trailer vehicle. The trailer network is preferably a trailer bus system, particularly preferably a trailer CAN. The trailer vehicle and the towing vehicle exchange trailer signals on the trailer network. Such signals are, for example, trailer signals of a trailer brake system of the vehicle, which include manipulated variables for brake actuators of the trailer vehicle. The trailer signals include geometric characteristics and/or load characteristics, which can advantageously be used by the vehicle control system in defining the driving dynamics limit value. It should be understood that, even when the vehicle is a vehicle train, two geometric characteristics and two load characteristics may be sufficient. These can then be included by signals on the trailer network, the vehicle network and/or the private network.

The second control unit is preferably a different control unit from the first control unit. Provision may also be made for the second control unit and the first control unit to be functionally distinguishable subunits of one control unit.

In a second aspect, the disclosure achieves the object mentioned at the outset via a vehicle having one or more vehicle actuators, a vehicle network, a private network and a vehicle control system according to one of the above-described embodiments of the first aspect of the disclosure. As a particular preference, the vehicle is a commercial vehicle.

In a third aspect, the object mentioned at the outset is achieved via a vehicle control method for controlling a vehicle, including the steps of: providing signals that include two or more geometric characteristics and two or more load characteristics of a current vehicle configuration of the vehicle on a vehicle network and/or private network; defining at least one driving dynamics limit value for the vehicle via a second control unit using the two or more geometric characteristics and the two or more load characteristics; providing the at least one driving dynamics limit value on a control system network that connects the second control unit to a first control unit; determining, via the first control unit, the driving dynamics limit value provided on the control system network; and determining a manipulated variable of a vehicle actuator of the vehicle via the first control unit using the vehicle dynamics limit value. As a particular preference, the vehicle control method is provided for controlling a commercial vehicle.

In a first embodiment of the vehicle control method, the defining of the at least one driving dynamics limit value for the vehicle via the second control unit using the two or more geometric characteristics and the two or more load characteristics includes: predicting dynamic properties of the current vehicle configuration via the second control unit using the two or more geometric characteristics and the two or more load characteristics; and defining the at least one driving dynamics limit value via the second control unit on the basis of the predicted dynamic properties.

### BRIEF DESCRIPTION OF DRAWINGS

The invention will now be described with reference to the drawings wherein:

FIG. 1 shows a plan view of a commercial vehicle according to an embodiment;

FIG. 2 shows a schematic illustration of a vehicle control system;

FIG. 3 shows a side view of the commercial vehicle according to the embodiment; and,

FIG. 4 shows a schematic flow diagram of a vehicle control system.

### DETAILED DESCRIPTION

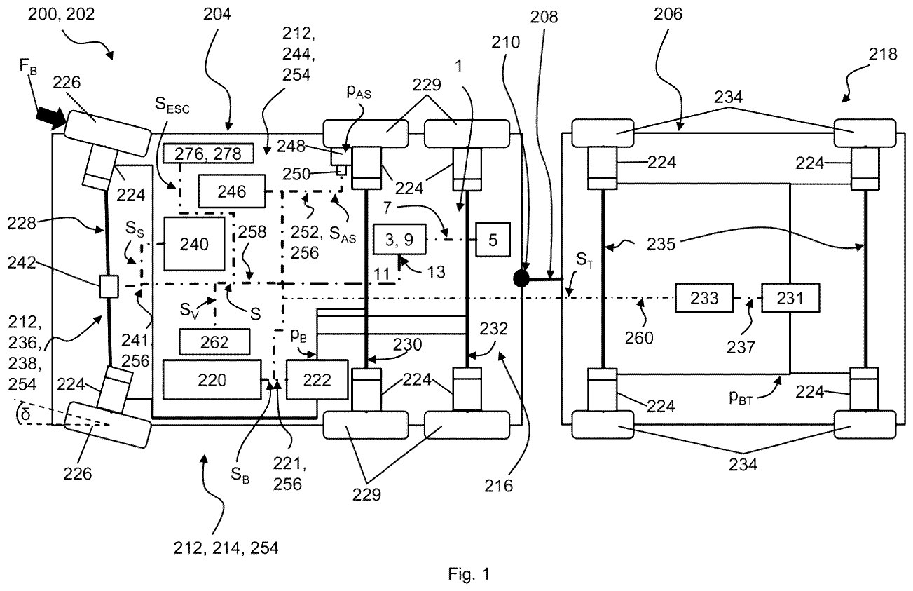

FIG. 1 shows a vehicle 200, which is a commercial vehicle 200 configured as a vehicle train 202. The vehicle train 202 includes a towing vehicle 204, to which a trailer vehicle 206 is attached. The towing vehicle 204 and the trailer vehicle 206 are connected via a drawbar 208 of the trailer vehicle 206, which is secured on a coupling point 210 of the towing vehicle 204. The commercial vehicle 200 includes a plurality of vehicle subsystems 212. A brake system 214 of the commercial vehicle 200 forms a first vehicle subsystem 212. The brake system 214 includes a towing vehicle brake system 216 for braking the towing vehicle 204 and a trailer vehicle brake system 218 for braking the trailer vehicle 206. The brake system 214 includes a brake control unit 220, a brake modulator 222 and brake cylinders 224. The brake cylinders 224 are assigned to front wheels 226 on a front axle 228 of the towing vehicle 204, to rear wheels 229 on a rear axle 230, and to a lift axle 232 of the towing vehicle 204, as well as to trailer wheels 234 on trailer axles 235 of the trailer vehicle 206. The brake control unit 220 and the brake modulator 222 are connected by a brake system network 221. The brake modulator 222 is connected pneumatically to the brake cylinders 224 of the towing vehicle 204 and provides a brake pressure p_{B} at the cylinders. It should be understood that brake pressures p_{B} assigned to the wheels 226, 229, 234 may be the same or different. Thus, for example, a brake pressure p_{B} can be output at the front wheels 226 which is different from a brake pressure p_{B} at the rear wheels 229. In the case of a braking intervention by a stability control system 276 (preferably an ESC 278), the brake pressures p_{B} may also differ within an axle 228, 230, 235 or between wheels 226, 229, 234 on an axle 228, 230, 235. In the case of an intervention by a traction control system (not illustrated in the figures), it is also possible, for example, in the case of braking of a spinning wheel 229 with a simultaneous reduction in a drive torque, for there to be different brake pressures p_{B} at the wheels 229 on the rear axle 230.

A trailer brake modulator 231 is connected to a trailer brake control unit 233 of the trailer vehicle brake system 218 by a trailer brake system network 237. The trailer brake modulator 231 provides a trailer brake pressure p_{BT} at the brake cylinders 224 of the trailer vehicle 206. The trailer brake pressure p_{BT} can also be the same or different for all the brake cylinders 224 of the trailer vehicle 206.

A steering system 236 of the commercial vehicle 200 forms a further vehicle subsystem 212. Here, the steering system 236 is an electronically controllable steering system 238, which includes a steering control unit 240 and a servomotor 242 for specifying a steering angle δ at the front wheels 226 of the commercial vehicle 200. A steering system network 241 connects the steering control unit 240 to the servomotor 242. The steering control unit 240 receives a manipulated variable 11 and controls the servomotor 242 in such a way that it outputs a steering angle δ corresponding to the manipulated variable 11 at the front wheels 226 of the commercial vehicle 200.

As a further vehicle subsystem 212, the commercial vehicle 200 includes an electronically controllable air spring system 244. The electronically controllable air spring system 244 has an air spring control unit 246 and air springs 248 assigned to the wheels 226, 228, 234 on the axles 228, 230, 235. FIG. 1 shows only one of the air springs 248 by way of example, and it should be understood that air springs 248 are provided at all the axles 228, 230, 235. The air springs 248 are provided with pressure sensors 250 in order to detect an air spring pressure p_{AS} acting in the air springs. The air spring pressure p_{AS} corresponds to a load acting at the air spring 248, thus enabling an axle load on the axles 228, 230, 235 to be determined on the basis of the air spring pressure p_{AS}. The pressure sensors 250 provide spring pressure signals S_{AS} corresponding to the respectively prevailing air spring pressure p_{AS} on a spring system network 252 which connects the pressure sensors 250 and the air springs 248 to the air spring control unit 246.

In the present embodiment, the brake system 214, the steering system 238 and the electronically controllable air spring system 244 represent vehicle actuators 254 of the commercial vehicle 200. The vehicle actuators 254 receive manipulated variables 11 and make driving dynamics interventions corresponding to the manipulated variables 11 on the commercial vehicle 200. Thus, for example, a brake cylinder 224 of the brake system 214 can be made, on the basis of a manipulated variable 11, to output a braking force F_{B} at a front wheel 226 of the commercial vehicle 200.

The brake system network 221, the steering system network 241 and the spring system network 252 are private networks 256 of the commercial vehicle 200. The commercial vehicle 200 furthermore has a vehicle network 258 and a trailer network 260. The vehicle network 258 connects the brake control unit 220, the steering control unit 240 and the air spring control unit 246 both to each other and to a main control unit 262 of the commercial vehicle 200. The trailer network 260 connects various units or subsystems of the trailer vehicle 206 to units or subsystems of the towing vehicle 204. Here, the trailer network 260 connects the trailer brake control unit 233 to the main control unit 262 and the vehicle network 258. Other vehicle subsystems 212 of the trailer vehicle 206 can also be connected to the towing vehicle 204 or the vehicle subsystems 212 thereof via the trailer network 260, although this has not been shown in FIG. 1.

The vehicle subsystems 212 provide signals S on the networks 256, 258, 260. Thus, trailer signals St_{T} are provided on the trailer network 260, vehicle signals S_{V} are provided on the vehicle network 258, steering signals S_{S} are provided on the steering system network 241, the brake signals S_{B} are provided on the brake system network 221, and the spring pressure signals S_{AS} are provided on the spring system network 252. The vehicle subsystems 212 can also be configured to provide the signals S_{S}, S_{B}, S_{AS} of the private networks 256 on the vehicle network 258. There, the signals S_{S}, S_{B}, S_{AS} may then also form vehicle signals S_{V}. However, the vehicle signals S_{V} may also be signals S provided on the vehicle network 258 by other vehicle subsystems 212 or by the main control unit 262.

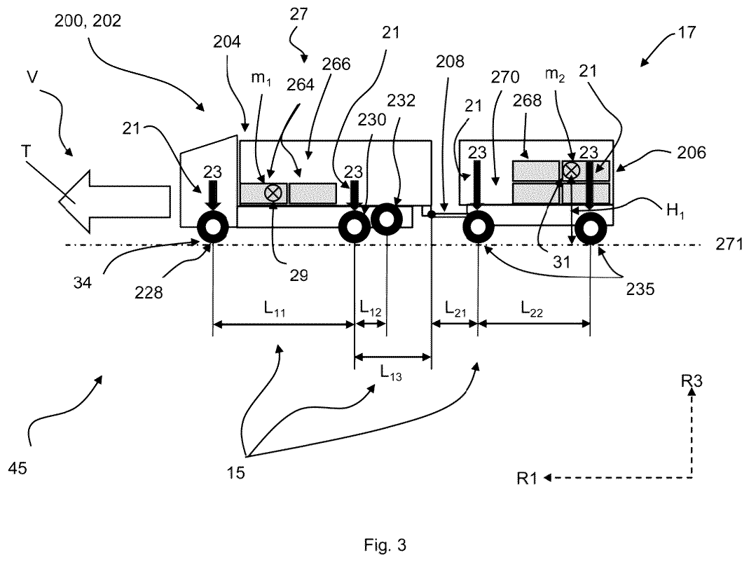

The commercial vehicle 200 furthermore has a vehicle control system 1 including a first control unit 3 and a second control unit 5. The first control unit 3 and the second control unit 5 are connected by a control system network 7. Here, the first control unit 3 is a virtual driver 9, which is configured to plan a trajectory T (cf. FIG. 3) for the commercial vehicle 200. In addition, the virtual driver 9 determines manipulated variables 11 for the vehicle actuators 254 and provides these at an actuator interface 13. The actuator interface 13 is preferably configured as a CAN interface.

Via the signal provided at the actuator interface 13, the virtual driver controls the vehicle actuators 254 in such a way that the commercial vehicle 200 follows the trajectory T determined by the virtual driver 9. In the present embodiment, the virtual driver 9 thus performs both the planning of the trajectory T and also determination of the manipulated variables 11 to be specified in order to follow the trajectory T. In alternative embodiments, however, provision may also be made for the virtual driver 9 to receive the trajectory T and perform only the determination of one or more manipulated variables 11. In such a case, the virtual driver 9 would then be configured primarily as a position controller.

FIG. 1 illustrates that the actuator interface 13 of the vehicle control system 1 is connected via the vehicle network 258 to the brake system 214, the steering system 238 and the electronically controllable air spring system 244. However, provision may also be made for the possibility of connecting the first control unit 3 individually or via separate networks to the vehicle actuators 254. The first control unit 3 provides the manipulated variables 11 via the actuator interface 13 and the vehicle network 258 at the vehicle actuators 254, which, in turn, perform driving dynamics interventions on the commercial vehicle 200 on the basis of the manipulated variables 11. The driving dynamics interventions make the commercial vehicle 200 follow the trajectory T.

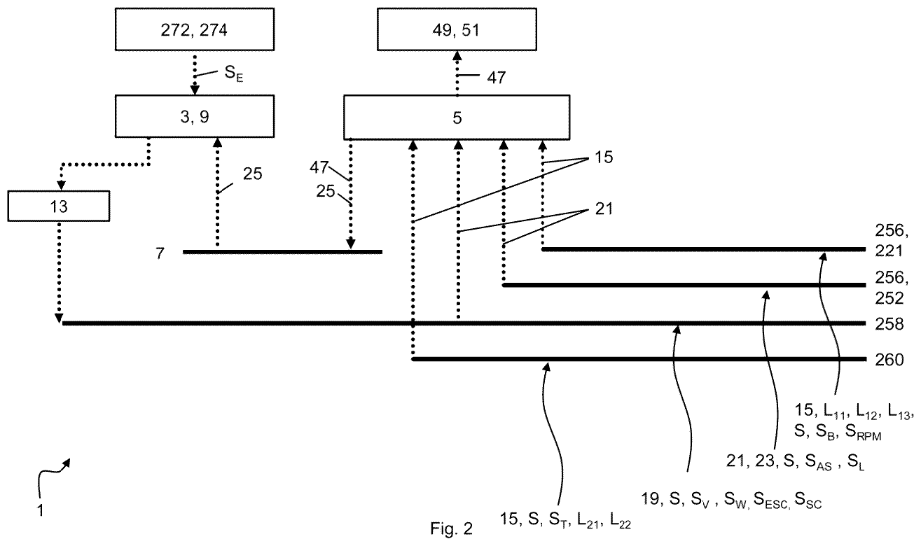

The second control unit 5 is connected to the vehicle network 258, a private network 256 and the trailer network 260. These connections are shown as dotted lines in FIG. 2. In this embodiment, a first private network 256, which is connected to the second control unit 5, is the brake system network 221. Here, the brake system network 221 is configured as a CAN bus system and provides the brake signals S_{B}, thus enabling these brake signals S_{B} to be read out by the second control unit 5. The brake signals S_{B} include data which represent an axle spacing L₁₁ between the front axle 228 and the rear axle 230 of the towing vehicle 204, a lift axle spacing L₁₂ between the rear axle 230 and the lift axle 232 of the towing vehicle 204, and a coupling distance L₁₃ between the rear axle 230 and the coupling point 210 (cf. FIG. 3). These spacings/distances L₁₁, L₁₂, L₁₃ are stored in the brake control unit 220 in order to enable conventional brake control of the commercial vehicle 200. Here, the conventional brake control is an anti-lock brake system (ABS) of the commercial vehicle 200, for example. The second control unit 5 receives the brake signals S_{B} and, from these, determines the spacings/distances L₁₁, L₁₂, L₁₃. These spacings/distances form geometric characteristics 15 of a current vehicle configuration 17 of the commercial vehicle, which are determined by the second control unit 5 using the brake signals S_{B}.

The second control unit 5 is furthermore connected to the vehicle network 258 and receives vehicle signals S_{V} provided on the vehicle network 258. Here, the vehicle signals S_{V} include a lift status 19 of the lift axle 232. In the current vehicle configuration 17, the lift axle 232 is raised (cf. FIG. 3), and therefore the lift status 19 represents a raised lift axle 232. The second control unit 5 determines the lift status 232 as a further geometric characteristic 15. In addition, the second control unit 5 is configured to further process the geometric characteristics 15. Thus, the second control unit 5 is configured to determine a wheelbase of the towing vehicle 204 as a further geometric characteristic 15 on the basis of the lift status 232 and the axle spacing L₁₁. As FIG. 3 illustrates, the wheelbase of the towing vehicle 204 corresponds to the axle spacing L₁₁ if the lift axle 232 is raised (as shown in FIG. 2) or to a distance between the front axle 228 and the lift axle 232 if the lift axle 232 is lowered. With the lift axle 232 lowered, the wheelbase of the towing vehicle 204 corresponds to the sum of the axle spacing L₁₁ and half the lift axle spacing L₁₃. The second control unit 5 determines further geometric characteristics 15 on the basis of the trailer signals S_{T}, which are provided on the trailer network 260. In the present embodiment, geometric characteristics 15 of the trailer vehicle 206 are a drawbar length L₂₁ between the coupling point 210 and the front axle 235 of the trailer vehicle 206, and a trailer wheelbase L₂₂, included by the axles 235 of the trailer vehicle 206. In the present case, the drawbar length L₂₁ and the trailer wheelbase L₂₂ are pre-stored in the trailer brake control unit 233 and are provided by the latter on the trailer network 260 in the form of corresponding trailer signals S_{T}.

Preferably, all the length dimensions of axles 228, 230, 232 of the towing vehicle 204 and/or further axle characteristics of the axles 228, 230, 232 (driven axle, steerability, liftability, type of tires) are pre-stored in the brake control unit 220 of the brake system 214 and are provided on the brake system network 221 by the brake control unit 220, enabling them to be determined by the second control unit 5. Via the trailer network 260, in particular via an ISO 11992 CAN bus, the trailer brake control unit 233 furthermore provides pre-stored data representing a type of the trailer vehicle 206, a number of the trailer axles 235, wheelbases of the trailer vehicle 206 and/or a distance between the coupling point 210 and the central point of an axle group (not illustrated). These data can then be determined by the second control unit 5.

The second control unit 5 is furthermore connected to a second private network 256, namely to the spring system network 252. On the basis of the spring pressure signals S_{AS}, which are provided on the spring system network 252, the second control unit 5 can determine axle loads 23 acting on the axles 228, 230, 235. In the present case, the second control unit 5 calculates an air spring force provided by the air springs 248 from the spring pressures p_{AS} represented by the spring pressure signals S_{AS} and from a corresponding pressure area of the air springs 248. This air spring force counteracts the weight of the vehicle 200 and of the load and therefore corresponds substantially to an axle load on the axle 228, 230, 235 to which the air spring 248 is assigned. The axle loads 23 represent load characteristics 21 of the current vehicle configuration 17 of the commercial vehicle 200. However, the axle loads 23 can also be determined directly by the electronically controllable air spring system 244 and provided on the spring system network 252 in the form of axle load signals S_{L} representing the axle loads 23. Furthermore, axle loads 23 on the trailer axle 235 can also be provided on the trailer network 260.

The load characteristics 21 characterize the current vehicle configuration 17 in respect of loads acting on the commercial vehicle 200. These loads result, on the one hand, from the dead weight of the commercial vehicle 200, which is preferably known and is provided on the vehicle network 258 as a load characteristic 21, and from a first load 264 on a first load surface 266 of the towing vehicle 204 and a second load 268 on a second loading surface 270 of the trailer vehicle 206.

FIG. 3 shows that the commercial vehicle 200 is unevenly loaded in the current vehicle configuration 17. The second load 268 on the second loading surface 270 of the trailer vehicle 206 is considerably heavier than the first load 264 on the first loading surface 266 of the towing vehicle 204. In this current vehicle configuration 17, the commercial vehicle 200 has a tendency for instability during steering since the heavily loaded trailer vehicle 206 may fishtail on account of a high-frequency steering excitation. Such a high-frequency steering excitation occurs, for example, when the commercial vehicle 200 must perform an avoidance maneuver to avoid a collision.

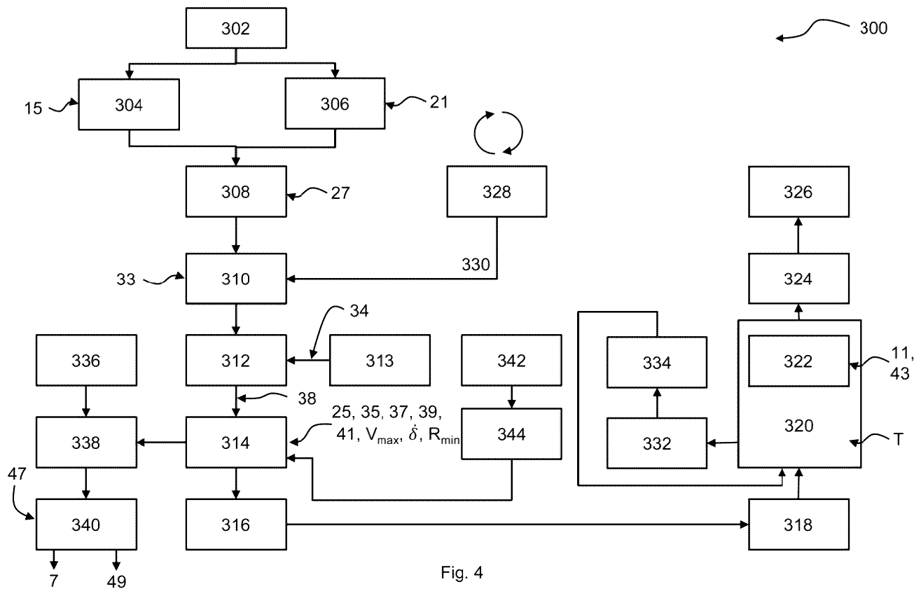

The second control unit 5 is configured to determine a driving dynamics limit value 25 for the current vehicle configuration 17 using the determined geometric characteristics 15 and the load characteristics 21. FIG. 4 illustrates, in the form of a schematic flow diagram, a vehicle control method 300 which is carried out by the vehicle control system 1 in order to define the driving dynamics limit value 25. The flow diagram illustrates provision 302 of signals S, which include two or more geometric characteristics 15 and two or more load characteristics 21, and the determination 304 of the geometric characteristics 15 of the current vehicle configuration 17 and the determination 306 of the load characteristics 21 of the current vehicle configuration 17 by the second control unit 5 as the first steps of the vehicle control method 300.

In a subsequent step, the second control unit 5 here first of all approximates a load distribution 27 of the current vehicle configuration 21 in a vehicle longitudinal direction R1 using the geometric characteristics 15 and the load characteristics 21 (approximation 308 in FIG. 4). It should be understood that the approximation of the mass distribution 27 may be subject to a certain approximation error. The mass distribution 27 includes the location of a first center of mass 29 of the towing vehicle 204 in the vehicle longitudinal direction R1 and the location of a second center of mass 31 of the trailer vehicle 206 in the vehicle longitudinal direction R1 (cf. FIG. 3). In addition, the mass distribution 27 in the present embodiment also includes the location of the centers of mass 29, 31 in a vehicle vertical direction R2, wherein the locations of the centers of mass in the vehicle vertical direction R2 are determined from a rolling behavior 38 of the commercial vehicle 200. The mass distribution 27 thus also includes a center of mass height H1 of the first center of mass 29. Furthermore, the mass distribution 27 includes a first mass m₁ of the towing vehicle 204 acting at the first center of mass 29 and a second mass m₂ of the trailer vehicle 206 acting at the second center of mass 31.

The second control unit 5 then generates an individualized vehicle model 33 by individualizing a basic vehicle model via the previously determined geometric characteristics 15 and the mass distribution 27 (generation 310 in FIG. 4). After this, the second control unit 5 performs a prediction 312 of dynamic properties of the current vehicle configuration 17 of the commercial vehicle 200 using this individualized vehicle model 33.

In the prediction 312 of dynamic properties, the second control unit 5 uses not only the geometric characteristics 15 and the mass distribution 27 but also a current adhesion coefficient 34 between the commercial vehicle 200 and a roadway 271 over which the commercial vehicle 200 is traveling. The second control unit 5 is configured to approximate the current adhesion coefficient 34 (approximation 313 in FIG. 4). Determining the current adhesion coefficient 34 for the commercial vehicle 200 further improves the quality of the prediction 312 of the dynamic properties of the current vehicle configuration 17. In reality, fluctuations in the current adhesion coefficient 34 often occur. Thus the adhesion coefficient 34 prevailing between the commercial vehicle 200 and the roadway 271 may be reduced in wet or icy conditions relative to dry conditions. This results in a considerable effect on the dynamic properties of the commercial vehicle 200. If the current adhesion coefficient 34 is taken into account in the prediction 312 of the dynamic properties, this may have an effect on the defined driving dynamics limit value 25, and safety in operating the commercial vehicle 200 is enhanced. In this embodiment, the second control unit 5 determines current weather conditions from weather signals S_{W} provided on the vehicle network 258. The second control unit 5 then selects from a database a predefined adhesion coefficient 34, which corresponds to the weather conditions determined and the mass distribution 27.

In the present embodiment, the dynamic properties determined in the context of the prediction 312 are natural angular frequencies and damping levels for eigenvalues of the individualized vehicle model. On the basis of the dynamic properties, the second control unit 5 then defines at least one driving dynamics limit value 25 for the current vehicle configuration 17 of the commercial vehicle 200 (definition 314 in FIG. 4). The defined driving dynamics limit value 25 is then provided on the control system network 7 by the second control unit 5 (provision 316 in FIG. 4).

As the trajectory T shown in FIG. 3 illustrates, the commercial vehicle 200 is driving steadily straight ahead and is stable. Owing to the rear-weighted load, however, the commercial vehicle 200 is susceptible to instability in the event of a sudden avoidance maneuver characterized by a high steering angle frequency. Depending on a current vehicle speed V, the trailer vehicle 206 is not sufficiently damped under certain circumstances with respect to an excitation of the commercial vehicle 200 caused by the avoidance maneuver, and breaks away. The second control unit 5 is configured to determine, on the basis of the dynamic properties determined, from what current vehicle speed V the commercial vehicle 200 becomes unstable for a typical steering excitation of an avoidance maneuver. The second control unit 5 defines this speed as a driving dynamics limit value 25 in the form of a maximum permissible vehicle speed Vₘₐₓ. As further driving dynamics limit values 25, the second control unit 5 defines a maximum permissible steering angle gradient \dot{δ}, a maximum permissible steering angle frequency 35, a minimum permissible bend radius Rₘᵢₙ, a maximum permissible vehicle acceleration 37 and a maximum permissible vehicle deceleration 39. On the basis of a determined rolling behavior 38 of the commercial vehicle, which is included by the dynamic properties, and on the basis of the location of the centers of mass 29, 31 in the vehicle vertical direction R2, the second control unit 5 also determines, as a further driving dynamics limit value 25, a maximum permissible lateral acceleration 41 of the commercial vehicle 200 that must be complied with in order to prevent the commercial vehicle 200 tipping over.

The first control unit 3 is connected to the control system network 7 and is configured to determine the driving dynamics limit values 25 provided by the second control unit 5 (determination 318 in FIG. 4). As already explained above, the first control unit 3 is a virtual driver 9, which plans the trajectory T for the commercial vehicle 200 and determines manipulated variables 11. The commercial vehicle 200 has an environment sensor 272, which in this case is a radar sensor 274. The radar sensor 274 detects an environment ahead of the vehicle and provides corresponding environment signals S_{E} for the virtual driver 9. On the basis of the environment signals S_{E}, the virtual driver 9 carries out trajectory planning 320 (cf. FIG. 4) to obtain the trajectory T. During trajectory planning 320, the virtual driver 9 in this embodiment first of all determines the path to be travelled by the commercial vehicle 200.

The virtual driver 9 then determines manipulated variables 11 for the vehicle actuators 254 (determination 322 in FIG. 4), which correspond to the path. Thus, the first control unit 3 determines manipulated variables 11 that must be provided at the vehicle actuators 254 to ensure that the commercial vehicle 200 travels the path included by the trajectory T. Thus, as a manipulated variable 11, the first control unit 3 determines a steering angle δ required to travel round a bend. The virtual driver 9 uses the driving dynamics limit values 25 in determining 222 the manipulated variables 11. Here, the manipulated variables 11 are selected in such a way that neither the manipulated variables 11 nor a vehicle behavior of the commercial vehicle 200 resulting from the manipulated variables 11 infringes one of the driving dynamics limit values 25. For example, a speed manipulated variable 43, determined for traveling the path, for engine control of an engine (not illustrated in the figures) is specified by the first control unit 3 in such a way that the maximum permissible vehicle speed Vₘₐₓ is not exceeded when traveling the trajectory T.

Following the determination 222, the first control unit 3 provides the manipulated variables 11 at the actuator interface 13 (provision 324 in FIG. 4). In this embodiment, the actuator interface 13 is connected to the vehicle network 258, and therefore the manipulated variables 11 are provided on the vehicle network 258. The vehicle actuators 254 determine the manipulated variables 11 from the vehicle network 258 and control the commercial vehicle 200 in accordance with the manipulated variables 11 (control 326 in FIG. 4). As a manipulated variable 11, the steering control unit 240 thus determines the steering angle δ or a manipulated variable signal representing the steering angle δ from the vehicle network 258. The steering control unit 240 processes the manipulated variable 11 and controls a corresponding actuating current to the servomotor 242, which then brings about steering of the front wheels 226 by the steering angle δ.

It should be understood that, in this embodiment, the trajectory T includes both the path and also driving dynamics variables and/or manipulated variables 11 characterizing the driving dynamics variables. If, on the other hand, the vehicle control system 1 provides a driver assistance function, there is no need for any trajectory planning 320. Thus, the manipulated variable 11 can preferably also be determined without planning of a path if the vehicle control system 1 is an adaptive cruise control which performs only control of the vehicle speed V of the commercial vehicle 200. In this case, the first control unit 3 can provide a manipulated variable 11 for the brake system 214 at the actuator interface 13, for example, if a prescribed minimum distance from a vehicle in front is undershot.

The second control unit 5 is configured to monitor the signals S on the vehicle network 258, the trailer network 260 and the private networks 256. A change 330 in a characteristic 15, 21 underlying the definition of the driving dynamics limit values 25 is detected by the second control unit 5 during this monitoring 328 of the signals S. The monitoring 328 takes places continuously in the vehicle control method 300 according to FIG. 4 but, alternatively, can also be repeated cyclically by the second control unit 5. In response to the determination of a change 330, the second control unit 5 adapts the driving dynamics limit values 25, these being generated again by the individualized vehicle model 33. After this, the second control unit 5 repeats the prediction 312 in order to determine dynamic properties of the now changed current vehicle configuration 17. Using the newly determined dynamic properties, the second control unit 5 adapts the driving dynamics limit values 25 and provides them again on the control system network 7, thus enabling the virtual driver 9 to take into account the adapted driving dynamics limit values 25 in the trajectory planning 320. In the present case, the monitoring 328 ensures that the virtual driver 9 is always provided with up-to-date driving dynamics limit values 25.

The virtual driver 9 provides the trajectory T determined in the course of trajectory planning 320 on the control system network 7 (provision 332 in FIG. 4). The second control unit 5 receives the trajectory T from the control system network 7 and determines whether the trajectory T infringes one of the driving dynamics limit values 25 defined by the second control unit 5 (determination 334 in FIG. 4). If, because of an error, the virtual driver 9 plans a trajectory T that includes a vehicle speed V which is higher than the maximum permissible vehicle speed Vₘₐₓ, defined as a driving dynamics limit value 25 defined by the second control unit 5, this is determined by the second control unit 5. In such a case, the trajectory T infringes the driving dynamics limit value 25, and, as a result, there is the risk of instability of the commercial vehicle 200. However, since the second control unit 5 detects the infringement of the driving dynamics limit value 25 by the trajectory T, suitable countermeasures can be taken. Thus, in the present embodiment, the second control unit 5 is configured to make the virtual driver 9 carry out the trajectory planning 320 again using the driving dynamics limit values 25. In addition to limit value definition, the second control unit 5 thus also performs an additional safety function since it determines infringements of the driving dynamics limit value 25 which result from an incorrect trajectory T even before they occur.

The second control unit 5 is furthermore configured to detect an infringement of one of the driving dynamics limit values 25 that occurs during the operation of the commercial vehicle 200. For this purpose, the second control unit 5 receives signals S that at least partially represent a real driving state 45 of the commercial vehicle 200 (reception 336 in FIG. 4). In this embodiment, the brake signals S_{B} provided on the brake system network 221 include wheel speed signals S_{RPM}, which represent a rotational speed of the front wheels 226 of the towing vehicle 204. The second control unit 5 receives the wheel speed signals S_{RPM} from the brake system network 221 and from these determines the current vehicle speed V. Here, therefore, the signals S representing the real driving state 45 of the commercial vehicle 200 are the wheel speed signals S_{RPM}. In other embodiments, however, the vehicle speed V can also be provided directly on one of the networks 256, 258, 260 connected to the second control unit 5. The second control unit 5 then determines whether the current vehicle speed V infringes the maximum permissible vehicle speed Vₘₐₓ defined as a driving dynamics limit value 25. In FIG. 4, this step of the vehicle control method 300 is illustrated as determining 338 whether the at least one driving dynamics limit value 25 is infringed in the real driving state 45. In the present embodiment, there is an infringement of the driving dynamics limit value 25 if the current vehicle speed V is higher than the maximum permissible vehicle speed Vₘₐₓ.

Here, the signals S representing the real driving state 45 of the commercial vehicle 200 furthermore include stability control signals S_{SC} of the stability control system 276, which represent a yaw rate, a steering angle and/or a lateral acceleration of the commercial vehicle 200, for example. On the basis of the stability control signals S_{SC}, the second control unit 5 determines whether a further driving dynamics limit value 25 is being infringed in the real driving state 45. This is the case, for example, if the steering angle δ of the commercial vehicle 200 is infringing a maximum permissible steering angle of the commercial vehicle 200 defined as a driving dynamics limit value 25 or would lead to a lateral acceleration of the commercial vehicle 200 that infringed a driving dynamics limit value 25.

If one or more driving dynamics limit values 25 are being infringed in the real driving state 45, the second control unit 5 outputs a warning signal 47 (output 336 in FIG. 4). Here, the warning signal 47 is output by the second control unit 5 both on the control system network 7 and on a man-machine interface 49 of the vehicle control system 1. Thus, the virtual driver 9 can receive the warning signal 47 from the control system network 7 and carry out trajectory planning 320 again or at least adapt a manipulated variable 11 corresponding to the infringed driving dynamics limit value 25. In addition, the warning signal 47 provided at the man-machine interface 49 of the vehicle control system 1 can be perceived by a human driver or a passenger of the commercial vehicle 200. The man-machine interface 49 is preferably a warning lamp 51 which lights up if a driving dynamics limit value 25 is infringed in the real driving state 45. This enables a human driver or passenger to possibly take over control of the commercial vehicle 200 from the virtual driver 9 if a driving dynamics limit value 25 is exceeded in the real driving state 45 and the virtual driver 9 does not perform an adaptation of the trajectory T or of the manipulated variables 11.

The commercial vehicle 200 furthermore has the stability control system 276. The stability control system 276 is a conventional electronic stability control 278 (ESC for short). In other embodiments, however, the stability control system 276 may also be an anti-lock brake system or a traction control system, for example. The ESC 278 monitors the real driving state 45 of the commercial vehicle 200 and intervenes with a stabilizing action in extreme situations. Selected intervention thresholds of the ESC 278 are high, ensuring that the ESC 278 intervenes reactively only when severe instability of the commercial vehicle 200 occurs. For this purpose, the ESC 278 provides ESC signals S_{ESC} on the vehicle network 258, which are then used by the vehicle actuators 254 to stabilize the commercial vehicle 200. The second control unit 5 is configured to detect the ESC signals S_{ESC} and, using the ESC signals S_{ESC}, to detect an intervention by the ESC 278. In FIG. 4, this is illustrated as detection 342 of an intervention of a stability control system 276, which can be carried out independently of the other steps of the vehicle control method 1. On the basis of the detected intervention by the ESC 278 or the ESC signals S_{ESC}, the second control unit 5 can derive dynamic restrictions on the commercial vehicle 200 which have caused the intervention by the ESC 278. For example, the second control unit 5 can determine a steering excitation (or an associated steering angle frequency) and/or a braking intervention at the rear axle 230 of the commercial vehicle 200, which have led to oversteer of the commercial vehicle 200. The second control unit 5 uses the result of the derivation 344 in defining 314 the driving dynamics limit value 25. Here, therefore, the maximum permissible steering angle frequency 35 defined by the second control unit 5 is at least smaller than the steering angle frequency causing the oversteer.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Vehicle control system
3 First control unit
5 Second control unit
7 Control system network
9 Virtual driver
11 Manipulated variable
13 Actuator interface
11 Geometric characteristic
17 Current vehicle configuration
19 Lift status
21 Load characteristic
23 Axle load
25 Driving dynamics limit value
27 Mass distribution
29 First center of mass
31 Second center of mass
33 Individualized vehicle model
34 Current adhesion coefficient
35 Maximum permissible steering angle frequency
37 Maximum permissible vehicle acceleration
38 Rolling behavior
39 Maximum permissible vehicle deceleration
41 Maximum permissible lateral acceleration
43 Speed manipulated variable
45 Real driving state
47 Warning signal
49 Man-machine interface
51 Warning lamp
200 Vehicle; commercial vehicle
202 Vehicle train
204 Towing vehicle
206 Trailer vehicle
208 Drawbar
210 Coupling point
212 Vehicle subsystem
214 Brake system
216 Towing vehicle brake system
218 Trailer vehicle brake system
220 Brake control unit
221 Brake system network
222 Brake modulator
224 Brake cylinder
226 Front wheel
228 Front axle
229 Rear wheel
230 Rear axle
231 Trailer brake modulator
232 Lift axle
233 Trailer brake control unit
234 Trailer wheel
235 Trailer axle
236 Steering system
237 Trailer brake system network
238 Electronically controllable steering system
240 Steering control unit
241 Steering system network
242 Servomotor
244 Electronically controllable air spring system
246 Air spring control unit
248 Air spring
250 Pressure sensor
252 Spring system network
254 Vehicle actuator
256 Private network
258 Vehicle network
260 Trailer network
262 Main control unit
264 First load
266 First load surface
268 Second load
270 Second load surface
271 Roadway
272 Environment sensor
274 Radar sensor
276 Stability control system
278 ESC
300 Vehicle control method
302 Provision of signals
304 Determination of geometric characteristics
306 Determination of load characteristics
308 Approximation of a mass distribution
310 Generation of an individualized vehicle model
312 Prediction of dynamic properties
313 Approximation of a current adhesion coefficient
314 Definition of at least one driving dynamics limit value
316 Provision of the driving dynamics limit value
318 Determination of the driving dynamics limit value by the first control unit
320 Trajectory planning
322 Determination of at least one manipulated variable
324 Provision of the manipulated variable at the actuator interface
326 Control of the commercial vehicle in accordance with the manipulated variable
328 Monitoring of signals
330 Change in a characteristic
332 Provision of the trajectory on the control system network
334 Determination whether the trajectory infringes a driving dynamics limit value
336 Reception of data representing a real driving state
338 Determination whether a driving dynamics limit value is infringed
340 Output of a warning signal
342 Detection of an
344 Derivation of dynamic restrictions
F_{B} Braking force
L₁₁ Axle spacing
L₁₂ Lift axle spacing
L₁₃ Coupling distance
L₂₁ Drawbar length
L₂₂ Trailer wheel base
m₁ First mass
m₂ Second mass
p_{AS} Air spring pressure
p_{B} Brake pressure
p_{BT} Trailer brake pressure
Rₘᵢₙ Minimum permissible bend radius
R1 Vehicle longitudinal direction
R2 Vehicle vertical direction
S Signal
S_{AS} Spring pressure signal
S_{B} Brake signal
S_{E} Environment signal
S_{ESC} ESC signal
S_{L} Axle load signal
S_{S} Steering signal
S_{SC} Stability control signal
S_{T} Trailer signal
S_{V} Vehicle signals
S_{W} Weather signals
T Trajectory
V Current vehicle speed
Vₘₐₓ Maximum permissible vehicle speed
δ Steering angle
\dot{δ} Maximum permissible steering angle gradient

1. A vehicle control system for a vehicle, wherein the vehicle has a vehicle network and a private network, the vehicle control system comprising:
a first control unit configured to determine a manipulated variable of a vehicle actuator of the vehicle and to output the determined manipulated variable of the vehicle actuator at an actuator interface;
a second control unit configured to be connected to the vehicle network and the private network in order to receive signals that include two or more geometric characteristics and two or more load characteristics of a current vehicle configuration of the vehicle;
a control system network which connects said first control unit and said second control unit;
said second control unit being configured to define a driving dynamics limit value of the current vehicle configuration using the two or more geometric characteristics and the two or more load characteristics and to provide the driving dynamics limit value on said control system network; and,
said first control unit being configured to determine the manipulated variable using the driving dynamics limit value.

2. The vehicle control system of claim 1, wherein said second control unit is further configured to predict dynamic properties of the current vehicle configuration using the two or more geometric characteristics and the two or more load characteristics and to define the driving dynamics limit value on a basis of the predicted dynamic properties.

3. The vehicle control system of claim 1, wherein the driving dynamics limit value is a maximum permissible vehicle speed, a maximum permissible lateral acceleration, a maximum permissible vehicle acceleration, a maximum permissible vehicle deceleration, a maximum permissible steering angle gradient, a maximum permissible steering angle frequency or a minimum permissible bend radius of the vehicle.

4. The vehicle control system of claim 1, wherein said second control unit is configured to monitor the signals for a change in a characteristic on which the definition of the driving dynamics limit value is based and to adapt the driving dynamics limit value to the change.

5. The vehicle control system of claim 1, wherein said first control unit is a virtual driver for the autonomous control of a vehicle; and, said virtual driver is configured to plan a trajectory in order to perform a driving task of the vehicle.

6. The vehicle control system of claim 5, wherein said first control unit is configured to provide the trajectory on said control system network; and, said second control unit is configured to determine whether the trajectory infringes the driving dynamics limit value.

7. The vehicle control system of claim 1, wherein the two or more geometric characteristics include at least a number of axles of the vehicle and an axle spacing between the axles of the vehicle.

8. The vehicle control system of claim 1, wherein said second control unit is configured to receive signals that represent a real driving state of the vehicle and to determine whether the driving dynamics limit value is being infringed in the real driving state.

9. The vehicle control system of claim 8, wherein said second control unit is further configured to provide a warning signal if the driving dynamics limit value is infringed.

10. The vehicle control system of claim 9 further comprising a man-machine interface for outputting the warning signal.

11. The vehicle control system of claim 9, wherein said second control unit is configured to provide the warning signal on said control system network.

12. The vehicle control system of claim 1, wherein the private network is a brake system network.

13. The vehicle control system of claim 1, wherein said second control unit is configured to detect interventions of a stability control system during operation of the vehicle and to define the driving dynamics limit value using dynamic restrictions on the vehicle derivable from the interventions of the stability control system.

14. The vehicle control system of claim 1, wherein said second control unit is configured to approximate a current adhesion coefficient for the vehicle and to define the driving dynamics limit value using the current adhesion coefficient.

15. The vehicle control system of claim 1, wherein said second control unit is configured to determine a center of mass height of the vehicle, taking into account signals which represent the rolling behavior of the vehicle and to define the driving dynamics limit value using the center of mass height determined.

16. The vehicle control system of claim 1, wherein the vehicle is a vehicle train including a towing vehicle and at least one trailer vehicle; and, said second control unit is configured to be connected to a trailer network of the vehicle in order to receive trailer signals which include at least one of a geometric characteristic and a load characteristic of the current vehicle configuration of the vehicle.

17. A vehicle comprising:
a vehicle actuator;
a vehicle network;
a private network;
a vehicle control system having a first control unit, a second control unit, and a control system network;
said first control unit being configured to determine a manipulated variable of said vehicle actuator and to output the determined manipulated variable of said vehicle actuator at an actuator interface;
said second control unit being configured to be connected to said vehicle network and said private network in order to receive signals that include two or more geometric characteristics and two or more load characteristics of a current vehicle configuration of the vehicle;
said control system network being configured to connect said first control unit and said second control unit;
said second control unit being configured to define a driving dynamics limit value of the current vehicle configuration using the two or more geometric characteristics and the two or more load characteristics and to provide the driving dynamics limit value on said control system network; and,
said first control unit being configured to determine the manipulated variable using the driving dynamics limit value.

18. A vehicle control method for controlling a vehicle, the method comprising:
providing signals that include two or more geometric characteristics and two or more load characteristics of a current vehicle configuration of the vehicle on at least one of a vehicle network and a private network;
defining at least one driving dynamics limit value for the vehicle via a second control unit using the two or more geometric characteristics and the two or more load characteristics;
providing the at least one driving dynamics limit value on a control system network that connects at least the second control unit to a first control unit;
determining, via the first control unit, the driving dynamics limit value provided on the control system network; and,
determining a manipulated variable of a vehicle actuator of the vehicle via the first control unit using the vehicle dynamics limit value.

19. The vehicle control method of claim 18, wherein said defining the at least one driving dynamics limit value for the vehicle via the second control unit using the two or more geometric characteristics and the two or more load characteristics includes:
predicting dynamic properties of the current vehicle configuration via the second control unit using the two or more geometric characteristics and the two or more load characteristics; and,
defining the driving dynamics limit value via the second control unit on a basis of the predicted dynamic properties.
